(19) United States
(12) Patent Application Publication
(10) Pub. No.: US 2021/0195005 A1
(43) Pub. Date: Jun. 24, 2021

(54) Mobile Terminal and Photographing System

(71) Applicant: GUANGDONG OPPO MOBILE TELECOMMUNICATIONS CORP., LTD., Dongguan (CN)

(72) Inventor: Jie Li, Dongguan (CN)

(21) Appl. No.: 17/192,054

(22) Filed: Mar. 4, 2021

Related U.S. Application Data
(63) Continuation of application No. PCT/CN2019/095737, filed on Jul. 12, 2019.

(30) Foreign Application Priority Data
Sep. 6, 2018 (CN) 201821460525.3

(51) Int. Cl. H04M 1/02; H04N 5/225

(52) U.S. Cl. CPC H04M 1/0264; H04M 2250/52; H04N 5/2254

(57) ABSTRACT

A mobile terminal includes a terminal device, an image acquisition device, a first elastic piece, and a locking tongue. The terminal device defines a mounting groove; the image acquisition device includes a casing and a camera module. The camera module is provided in the casing; the image acquisition device can be mounted in the mounting groove, the casing defines a clamping groove, and the first elastic piece protrudes in the mounting groove; the locking tongue is slidably connected to the terminal device, and the locking tongue can slide to a first position and a second position; at the first position, the locking tongue locks the image acquisition device in the mounting groove and the first elastic piece abuts against the image acquisition device; at the second position, the first elastic piece ejects the image acquisition device out of the mounting groove.

### CROSS-REFERENCE TO RELATED APPLICATION(S)

The present application is a continuation-application of International (PCT) Patent Application No. PCT/CN2019/095737 filed on Jul. 12, 2019, which claims priority of Chinese Patent Application No. 201821460525.3, filed on Sep. 6, 2018, the entire contents of both of which are hereby incorporated by reference.

### TECHNICAL FIELD

The present disclosure relates to the field of mobile terminals, and in particular to a mobile terminal and a photographing system.

### BACKGROUND

A typical mobile terminal (a mobile phone, a tablet, etc.) may be configured with a camera, and the camera may be configured to provide functions such as video calling and image capturing, and a scene to be captured by the camera may be relatively single.

### SUMMARY

According to a first aspect of the present disclosure, a mobile terminal is provided and includes following components.

A terminal device includes a display screen, a first power module, and a first wireless communication module, wherein the first power module is configured to supply power for the display screen and the first wireless communication module, a side of the terminal device opposite to a display region of the display screen defines a mounting groove.

An image capturing device includes a cover, a camera module, a second power module, and a second wireless communication module, wherein the second power module is configured to supply power for the camera module and the second wireless communication module, the camera module and the second power module are disposed inside the cover, the camera module has a light incidence face exposed from the cover, the image capturing device is capable of being received in the mounting groove to allow the light incidence face to be exposed from the side of the terminal device opposite to the display region, the cover defines a slot.

A first elastic member is connected to the terminal device and protruding from a wall of the mounting groove and extending towards the mounting groove.

A lock tongue is slidably connected to the terminal device and is capable of sliding to reach a first position and a second position. After the image capturing device is received in the mounting groove, the lock tongue is at least partially received in the slot and fastened with a wall of the slot, the image capturing device is locked in the mounting groove, and the first elastic member abuts against the image capturing device, when the lock tongue is at the first position. The lock tongue is released from the slot, and the first elastic member is configured to eject the image capturing device out of the mounting groove to allow the image capturing device to be detached from the mounting groove, when the lock tongue is at the second position.

According to a second aspect of the present disclosure, a mobile terminal is provided and includes following components.

A terminal device includes a display screen and a first wireless communication module, wherein the display screen has a display region, and a side of the terminal device opposite to the display region defines a mounting groove.

An image capturing device is detachably connected to the terminal device and includes a cover, a camera module, and a second wireless communication module. The cover defines a slot, the camera module is disposed inside the cover. The camera module has a light incidence face. When the image capturing device is received in the mounting groove, the light incidence face is exposed from the side of the terminal device opposite to the display region. The image capturing device is communicatively connected to the first wireless communication module through the second wireless communication module.

A first elastic member is connected to the terminal device, protruding from a wall of the mounting groove and extending towards the mounting groove.

A lock tongue is slidably connected to the terminal device. The lock tongue is capable of sliding to reach a first position and a second position. When the image capturing device is received in the mounting groove, the lock tongue is slidable to reach the first position, and the lock tongue is fastened with a wall of the slot to maintain the image capturing device to be received in the mounting groove, and the first elastic member abuts against the image capturing device. The lock tongue is slidable to reach the second position to be released from the slot, and the first elastic member is configured to eject the image capturing device out of the mounting groove.

According to a third aspect of the present disclosure, a photographing system is provided and is capable of switching between a first state and a second state. The photographing system includes a first device, a second device, and an engaging assembly. The first device includes a body and a first communication module. The body includes a front side, a rear side opposite to the front side, the first communication module is disposed inside the body, and the rear side is recessed inwardly to define a first chamber and a second chamber. The second device includes a cover, a camera module, and a second communication module. The cover defines a slot, the camera module and the second power module are disposed inside the cover, the camera module has a light incidence face, the light incidence face is exposed from the cover of the second device, and the second communication module is communicatively connected to the first communication module. The engaging assembly includes a lock tongue and an elastic member. The lock tongue is at least partially received in the second chamber and is slidable relative to the rear side to be received in the first chamber or to be taken out of the first chamber. The elastic member is connected to the first device and disposed on a wall of the first chamber. When the photographing system is in the first state, the second device is received in the first chamber, the lock tongue is at least partially received in the first chamber, further received in the slot, and fastened with a wall of the slot, the elastic member is elastically deformed and abuts against the second device, and the light incidence face is exposed from the rear side of the first device. When the lock tongue slides to be out of the first chamber, the second device is capable of being taken out of the first chamber and the photographing system is in the second state. When the photographing system is in the second state, the second device is released from the first chamber, the lock tongue is at least partially received in the first chamber, and the elastic member protrudes from the wall of the first chamber and is at least partially received in the first chamber.

### BRIEF DESCRIPTION OF DRAWINGS

In order to clearly describe technical solutions of the embodiments of the present disclosure or in the prior art, accompanying drawings for the description of the embodiments or the prior art will be introduced in brief. Obviously, the drawings in the following description are only some embodiments of the present disclosure. Any ordinary skilled in the art may obtain other drawings based on the following drawings without creative work.

FIG. 1 is a perspective view of an image capturing device received in a mounting groove of a mobile terminal according to an embodiment of the present disclosure.

FIG. 2 is a front view of the image capturing device received in the mounting groove of the mobile terminal shown in FIG. 1.

FIG. 3 is a perspective view of the image capturing device taken out of the mounting groove of the mobile terminal shown in FIG. 2.

FIG. 4 is an enlarged view of a portion C of the mobile terminal shown in FIG. 3.

FIG. 5 is an exploded perspective view of the image capturing device of the mobile terminal shown in FIG. 3.

FIG. 6 is a perspective view of the image capturing device of the mobile terminal shown in FIG. 5, omitting a cover shell.

FIG. 7 is a cross-sectional view of the mobile terminal shown in FIG. 2, taken along the line VII-VII.

FIG. 8 is an enlarged view of a portion D of the mobile terminal shown in FIG. 7.

FIG. 9 is a cross-sectional view of the mobile terminal shown in FIG. 2 taking along the line IX-IX.

FIG. 10 is an application scenario of the image capturing device of the mobile terminal shown in FIG. 3.

FIG. 11 is an enlarged view of a portion E of the mobile terminal shown in FIG. 7.

### DETAILED DESCRIPTION

In order to facilitate the understanding of the present disclosure, the present disclosure will be the comprehensively described by referring to the accompanying drawings. The drawings show preferred embodiments of the present disclosure. However, the present disclosure may be implemented in many different forms and is not limited to the embodiments described herein. On the contrary, the purpose of providing these embodiments is to enable the present disclosure to be understood more thoroughly and comprehensively.

The “terminal device” hereinafter may refer to, but is not limited to, a device that receives and/or sends communication signals and is connected via one or more of the following connection manners:

(1) connected via a wired line, such as public switched telephone networks (PSTN), a digital subscriber line (DSL), a digital cable, and direct cable connection;

(2) connected via a wireless interface, such as a cellular network, a Wireless Local Area Network (WLAN), a digital TV network such as a DVB-H network, a satellite network, and an AM-FM broadcast transmitter.

A terminal device set to communicate through a wireless interface may be referred to as the “mobile terminal.” Examples of mobile terminals may include but are not limited to the following electronic devices:

(1) a satellite phone or a cellular phone;

(2) a personal communication system (PCS) terminal that combines a cellular radio telephone with data processing, faxing and data communication capabilities;

(3) a radio telephone, a pager, an Internet/Intranet access, a Web browser, a notebook, a calendar, a personal digital assistant (PDA) installed with a Global Positioning System (GPS) receiver;

(4) a conventional laptop and/or palmtop receiver;

(5) a conventional laptop and/or palmtop radio telephone transceiver, etc.

According to a first aspect of the present disclosure, a mobile terminal is provided and includes following components. A terminal device includes a display screen, a first power module, and a first wireless communication module, wherein the first power module is configured to supply power for the display screen and the first wireless communication module, a side of the terminal device opposite to a display region of the display screen defines a mounting groove. An image capturing device includes a cover, a camera module, a second power module, and a second wireless communication module, wherein the second power module is configured to supply power for the camera module and the second wireless communication module, the camera module and the second power module are disposed inside the cover, the camera module has a light incidence face exposed from the cover, the image capturing device is capable of being received in the mounting groove to allow the light incidence face to be exposed from the side of the terminal device opposite to the display region, the cover defines a slot. A first elastic member is connected to the terminal device and protruding from a wall of the mounting groove and extending towards the mounting groove. A lock tongue is slidably connected to the terminal device and is capable of sliding to reach a first position and a second position. After the image capturing device is received in the mounting groove, the lock tongue is at least partially received in the slot and fastened with a wall of the slot, the image capturing device is locked in the mounting groove, and the first elastic member abuts against the image capturing device, when the lock tongue is at the first position. The lock tongue is released from the slot, and the first elastic member is configured to eject the image capturing device out of the mounting groove to allow the image capturing device to be detached from the mounting groove, when the lock tongue is at the second position.

In some embodiments, the terminal device includes a rear wall and a side wall connected to an outer periphery of the display screen; the rear wall is disposed on the side of the terminal device opposite to the display region and is connected to the side wall; the side wall includes a left side wall, a right side wall opposite to the left side wall, a top side wall, and a bottom side wall opposite to the top side wall; the left side wall and the right side wall are disposed between the top side wall and the bottom side wall; the top side wall and the bottom side wall are disposed between the left side wall and the right side wall; the mounting groove extends through the rear wall; the mounting groove is defined between the left side wall and the right side wall, and is defined between the top side wall and the bottom side wall.

In some embodiments, a side of the rear wall opposite to the display region defines a groove extending through a thickness of the rear wall; the lock tongue includes a body portion and a slide block connected to the body portion; the slide block extends through the groove; and the body portion is switched between the first position and the second position by sliding engagement between the slide block and the groove.

In some embodiments, the groove includes a slide groove and a reservation groove communicating with the slide groove; the slide block includes a limiting portion and a connection portion, the limiting portion and the connection portion are connected with each other to be an integral structure; the connection portion is received in and extends through the reservation groove and is detachably connected to the body portion; the limiting portion is slidably received in the slide groove and is exposed from the side of the rear wall opposite to the display region.

In some embodiments, a size of a cross section of the reservation groove is greater than that of the connection portion, and the size of the cross section of the reservation groove is less than that of the limiting portion.

In some embodiments, the mobile terminal further includes a second elastic member. One end of the second elastic member abuts against the body portion, the other end of the second elastic member abuts against the terminal device. The second elastic member is configured to push the body portion from the second position to the first position to allow the body portion to be at least partially received in the mounting groove.

In some embodiments, the terminal device has a first groove wall and a second groove wall opposite to the first groove wall; compared to the second groove wall, the first groove wall is closer to the top side wall; the body portion protrudes from the second groove wall when the lock tongue is at the first position; the first groove wall is arranged with a protrusion, the protrusion protrudes from the first groove wall and extends towards the mounting groove; the cover defines a positioning recess; and after the image capturing device is received in the mounting groove, the protrusion is received in the positioning recess and fastened with a wall of the positioning recess.

In some embodiments, the second groove wall is inclined towards a side at which the bottom side wall is disposed to serve as a draft angle.

In some embodiments, the image capturing device includes a module contact, the terminal device includes a device contact. When the image capturing device is received in the mounting groove, the module contact is in contact with and connected to the device contact to allow the terminal device to charge the image capturing device.

In some embodiments, the image capturing device includes a module main board disposed inside the cover; the second power module is stacked on the module main board and is configured to supply power for the module main board; the module main board is communicatively connected to the camera module and the second wireless communication module; the module main board defines a first through hole, the camera module includes a lens tube, the light incidence face is exposed at an end of the lens tube, and the lens tube extends through the first through hole.

In some embodiments, the second power module defines a second through hole, the second through hole communicates with the first through hole, and the lens tube extends through the second through hole.

According to a second aspect of the present disclosure, a mobile terminal is provided and includes following components. A terminal device includes a display screen and a first wireless communication module, wherein the display screen has a display region, and a side of the terminal device opposite to the display region defines a mounting groove. An image capturing device is detachably connected to the terminal device and includes a cover, a camera module, and a second wireless communication module. The cover defines a slot, the camera module is disposed inside the cover. The camera module has a light incidence face. When the image capturing device is received in the mounting groove, the light incidence face is exposed from the side of the terminal device opposite to the display region. The image capturing device is communicatively connected to the first wireless communication module through the second wireless communication module. A first elastic member is connected to the terminal device, protruding from a wall of the mounting groove and extending towards the mounting groove. A lock tongue is slidably connected to the terminal device. The lock tongue is capable of sliding to reach a first position and a second position. When the image capturing device is received in the mounting groove, the lock tongue is slidable to reach the first position, and the lock tongue is fastened with a wall of the slot to maintain the image capturing device to be received in the mounting groove, and the first elastic member abuts against the image capturing device. The lock tongue is slidable to reach the second position to be released from the slot, and the first elastic member is configured to eject the image capturing device out of the mounting groove.

In some embodiments, the terminal device includes a rear wall and a side wall connected to an outer periphery of the display screen; the rear wall is disposed on the side opposite to the display region and is connected to the side wall; and the mounting groove is defined to extend through a thickness of the rear wall.

In some embodiments, the cover includes a front end face, a rear end face opposite to the front end face, and a side end face connected between the front end face and the rear end face; the side end face includes a left end face, a right end face opposite to the left end face, a top end face, and a bottom end face opposite to the top end face; the left end face and the right end face are disposed between the top end face and the bottom end face; the top end face and the bottom end face are disposed between the left end face and the right end face; the light incidence face is exposed from the front end face. When the image capturing device is received in the mounting groove, the front end face flushes with an outer surface of the rear wall.

In some embodiments, a side of the rear wall opposite to the display region further defines a receiving groove communicating with the mounting groove; the lock tongue includes a body portion and a slide block connected to the body portion; the slide block is received in the receiving groove; and the slide block is slidable along the receiving groove to drive the body portion to switch between the first position and the second position.

In some embodiments, the groove includes a slide groove and a reservation groove; the slide block includes a limiting portion and a connection portion, the limiting portion and the connection portion are connected with each other; the connection portion is received in and extends through the reservation groove and is connected to the body portion; the limiting portion is slidably received in the slide groove and is exposed from the side of the rear wall opposite to the display region.

In some embodiments, a size of a cross section of the reservation groove is greater than that of the connection portion, and the size of the cross section of the reservation groove is less than that of the limiting portion.

According to a third aspect of the present disclosure, a photographing system is provided and is capable of switching between a first state and a second state. The photographing system includes a first device, a second device, and an engaging assembly. The first device includes a body and a first communication module. The body includes a front side, a rear side opposite to the front side, the first communication module is disposed inside the body, and the rear side is recessed inwardly to define a first chamber and a second chamber. The second device includes a cover, a camera module, and a second communication module. The cover defines a slot, the camera module and the second power module are disposed inside the cover, the camera module has a light incidence face, the light incidence face is exposed from the cover of the second device, and the second communication module is communicatively connected to the first communication module. The engaging assembly includes a lock tongue and an elastic member. The lock tongue is at least partially received in the second chamber and is slidable relative to the rear side to be received in the first chamber or to be taken out of the first chamber. The elastic member is connected to the first device and disposed on a wall of the first chamber. When the photographing system is in the first state, the second device is received in the first chamber, the lock tongue is at least partially received in the first chamber, further received in the slot, and fastened with a wall of the slot, the elastic member is elastically deformed and abuts against the second device, and the light incidence face is exposed from the rear side of the first device. When the lock tongue slides to be out of the first chamber, the second device is capable of being taken out of the first chamber and the photographing system is in the second state. When the photographing system is in the second state, the second device is released from the first chamber, the lock tongue is at least partially received in the first chamber, and the elastic member protrudes from the wall of the first chamber and is at least partially received in the first chamber.

In some embodiments, the lock tongue includes a body portion and a slide block connected to the body portion; the slide block extends through the second chamber; the body portion is switched between a first position and a second position by sliding the slide block in the second chamber, when the photographing system is in the first state, the body portion is at the first position, and when the photographing system is in the second state, the body portion is at the second position; the second chamber includes a slide groove and a reservation groove communicating with the slide groove; the slide block includes a limiting portion and a connection portion, the limiting portion and the connection portion are connected with each other to be an integral structure; the connection portion is received in and extends through the reservation groove and is detachably connected to the body portion; and the limiting portion is slidably received in the slide groove and is exposed from the side of the rear wall opposite to the display region.

In some embodiments, the photographing system further includes another elastic member. One end of the another elastic member abuts against the body portion, the other end of the another elastic member abuts against the first device. The another elastic member is configured to push the body portion from the second position to the first position to allow the body portion to be at least partially received in the first chamber.

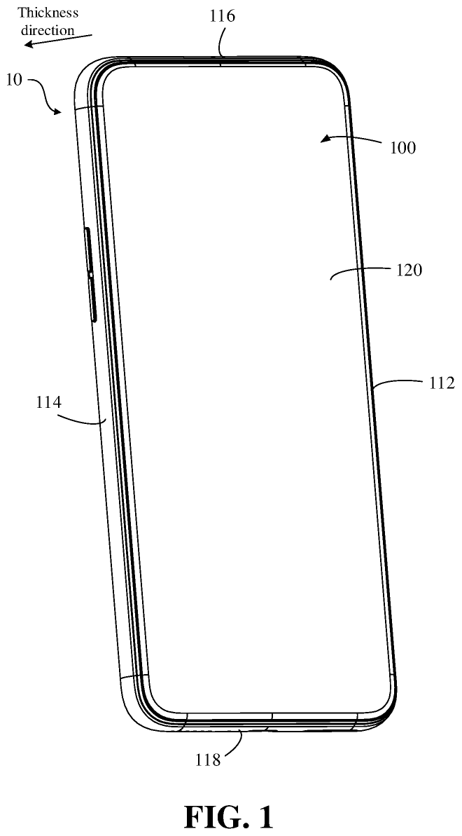

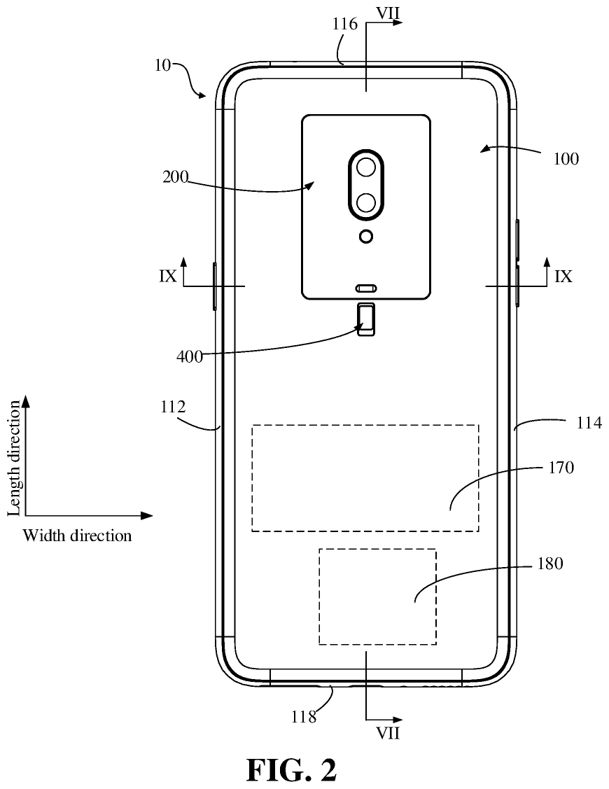

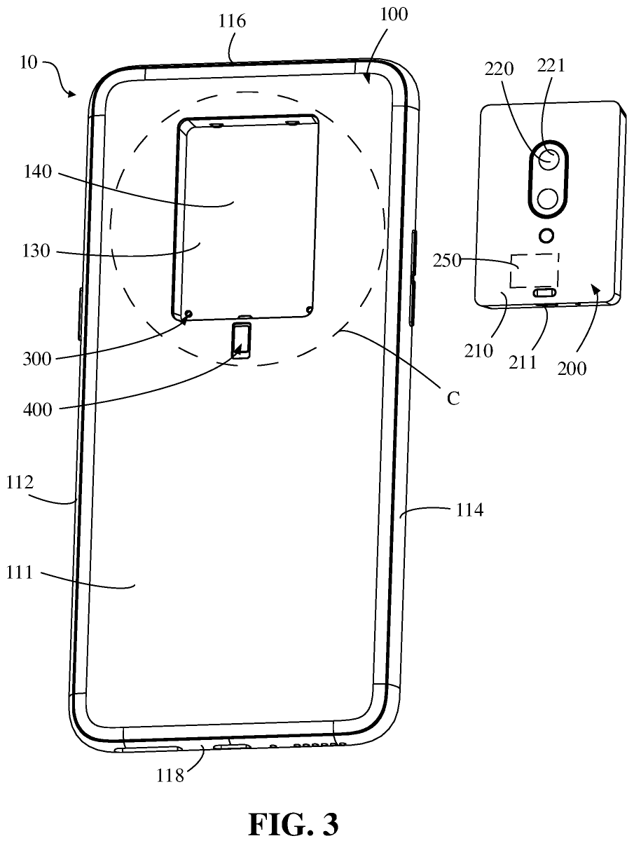

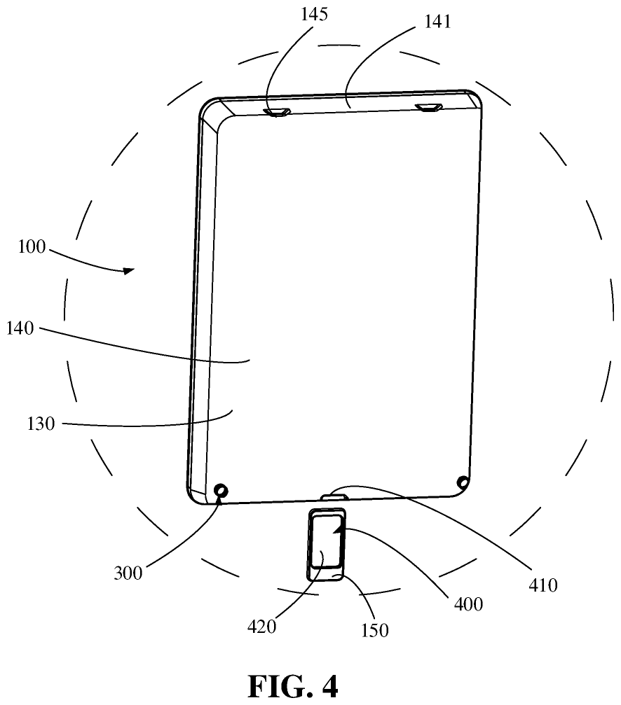

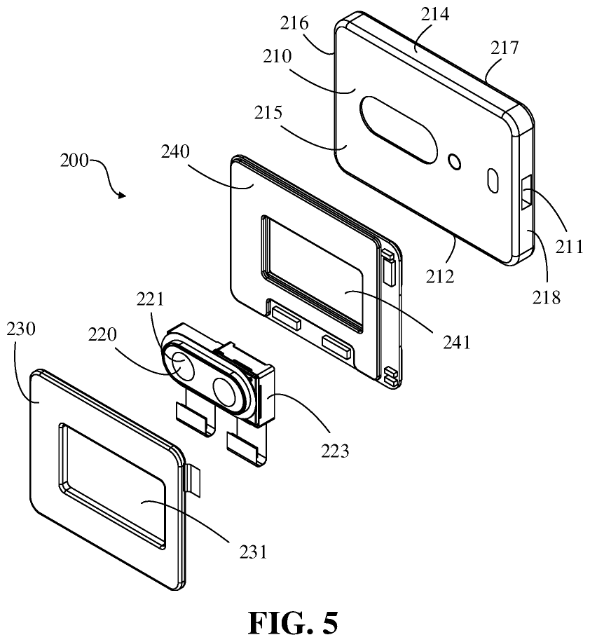

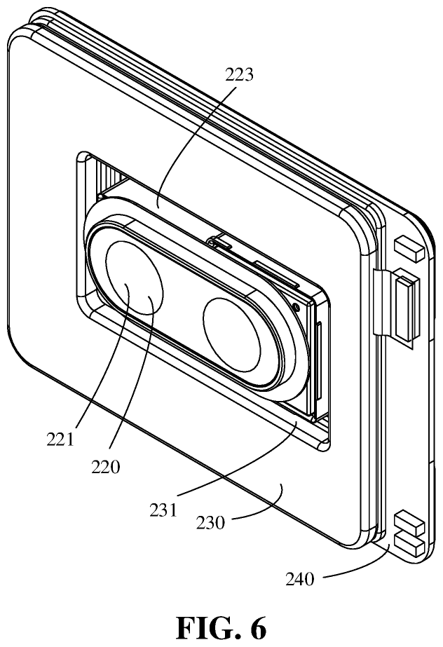

As shown in FIG. 1, FIG. 2, and FIG. 3, in one embodiment, a mobile terminal 10 may be a smart mobile phone. The mobile terminal 10 may include a terminal device 100, an image capturing device 200, a first elastic member 300 and a lock tongue 400. The terminal device 100 may include a display screen 120, a first power module 170, and a first wireless communication module 180. The first power module 170 may supply power for display screen 120 and the first wireless communication module 180. The display screen 120 may be configured to display information and to provide an interaction interface for a user. As shown in FIG. 4, a side of the terminal device 100 away from a display region of the display screen 120 may define a mounting groove 130. Further, as shown in FIG. 5 and FIG. 6, the image capturing device 200 may include a cover 210, a camera module 220, a second power module 230, and a second wireless module. The second power module 230 may supply power for the camera module 220 and the second wireless communication module 250. The camera module 220 and the second power module 230 may be disposed inside the cover 210. The camera module 220 may have a light incidence face 221, and the light incidence face 221 may be exposed from the cover 210. An ambient light may pass through the light incidence face 221 to reach a photosensitive element of the camera module 220. The image capturing device 200 may be received in the mounting groove 130, such that the light incidence face 221 may be exposed from the side of the terminal device away from the display region of the display screen 120. The cover 210 may define a slot 211.

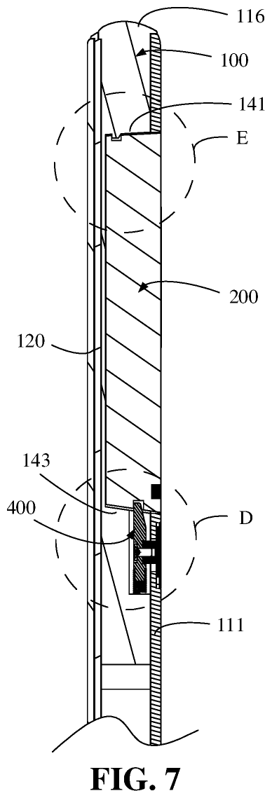

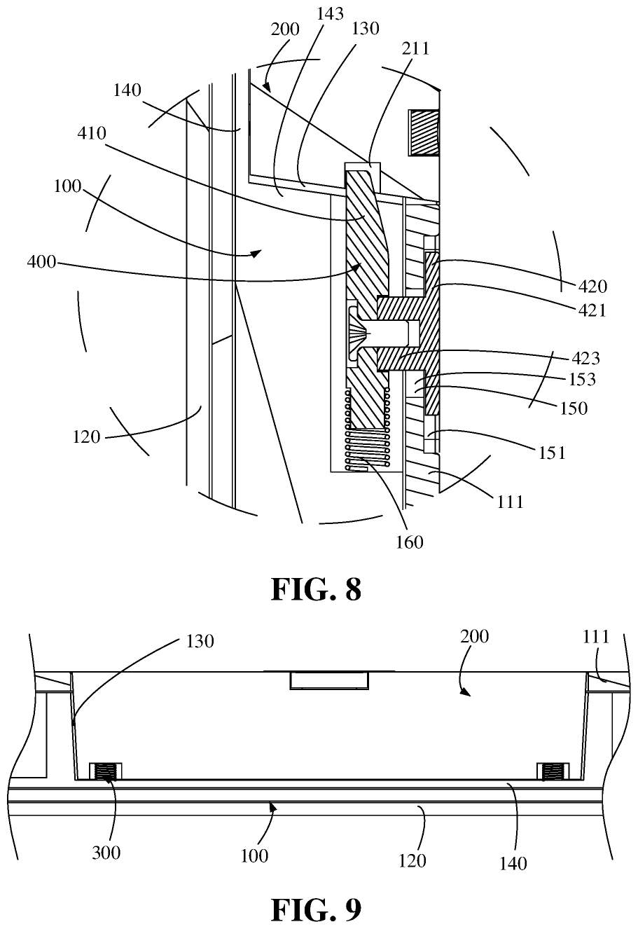

As shown in FIG. 4, the first elastic member 300 may be connected to the terminal device 100, protruding from a wall of the mounting groove 130 and extending towards the mounting groove 130. As shown in FIG. 7 and FIG. 8, the lock tongue 400 may be slidably connected to the terminal device 100, and more specifically, the lock tongue 400 may slide to reach a first position and a second position. As shown in FIG. 8, after the image capturing device 200 is received in the mounting groove 130, the lock tongue 400 may slide to the first position. In detail, when the lock tongue 400 is at the first position, the lock tongue 400 may be received in the slot 211 and fastened with a wall of the slot 211. The image capturing device 200 may be securely received in the mounting groove 130, and the first elastic member 300 may abut against the image capturing device 200 and may be elastically deformed by the image capturing device 200. When the lock tongue 400 slides to reach the second position, the lock tongue 400 may be released out of the slot 211. Further as shown in FIG. 9, the first elastic member 300 may eject the image capturing device 200 out of the mounting groove 130 such that the image capturing device 200 may be detached from the mounting groove 130. After detaching the image capturing device 200 from the mounting groove 130, the second wireless communication module 250 may be communicatively connected to the first wireless communication module 180, such that the image capturing device 200 may be communicatively connected to the terminal device 100. In other embodiments, the mobile terminal 10 may be a tablet.

The first wireless communication module 180 and the second communication module may be configured for data transmission between the terminal device 100 and the image capturing device 200. A near field communication technology may be applied in the first wireless communication module 180 and the second wireless communication module 250, and a same communication protocol may be applied in the first wireless communication module 180 and the second wireless communication module 250. For example, both of the first wireless communication module 180 and the second wireless communication module 250 may be Bluetooth communication modules, Wireless Fidelity (Wi-Fi) communication module, infrared data association (IrDA) modules, ZigBee communication modules, ultra wideband modules, or near field communication (NFC) modules, etc. In one embodiment, the terminal device 100 may include a third wireless communication module, and the third wireless communication module may be configured to communicatively connect to an external device, such as a base station or other mobile terminals 10, such that various mobile terminals 10 may communicate easily.

It should be understood that, in response to the image capturing device 200 being securely received in the mounting groove 130, the image capturing device 200 may communicatively connect to the first wireless communication module 180 through the second wireless communication module 250. In this situation, the camera module 220 is able to serve as a rear camera. The user may use the image capturing device 200 to capture an image distantly, to record a video, and the like. After the image capturing device 200 is detached from the mounting groove 130, the second wireless communication module 250 may be communicatively connected to the first wireless communication module 180. In this situation, the user may use the image capturing device 200 to capture images from various angles and to capture various scenes.

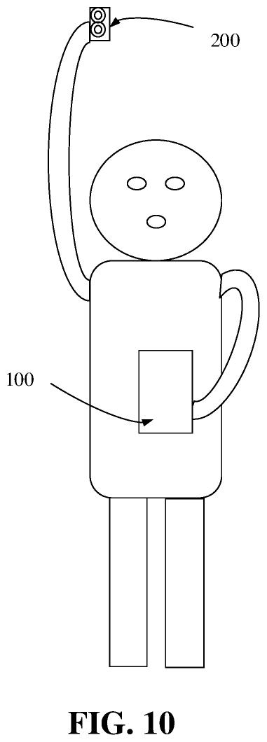

In the mobile terminal 10 as described in the above, the image capturing device 200 may be securely received in the mounting groove 130 and detached from the mounting groove 130. After the image capturing device 200 being detached from the mounting groove 130, the image capturing device 200 may communicatively connect to the first wireless communication module 180 of the terminal device 100 through the second wireless communication module 250, and the user may use the image capturing device 200 to capture images from various angles and to capture various scenes. As shown in FIG. 10, in one embodiment, the user may use one hand to hold the image capturing device 200, and use the other hand to hold the terminal device 100. The user may use the image capturing device 200 to capture images from various positions and various angles, and view the captured images through the display screen 120 of the terminal device 100. In another example, the user may place the image capturing device 200 at a certain location, and stand at another location and view the images captured by the image capturing device 200 through the terminal device 100. It should be understood that, as the image capturing device 200 is able to be detached from the terminal device 100, and is able to communicatively connect to the terminal device 100 after being detached, a front camera may not be required to be configured on a side of the terminal device 100 on which the display screen 120 is disposed. Therefore, a screen-to-body ratio of the terminal device 100 may be improved. For example, by configuring the terminal device 100 in the above-mentioned structure, the screen-to-body ratio may be over 85%. It should be understood that configuration of the first elastic member 300 and the lock tongue 400 may enable the image capturing device 200 to be fixedly received in the mounting groove 130, preventing the image capturing device 200 from being released out of the mounting groove 130 easily. When the lock tongue 400 is released from the slot 211 by unfastening with the wall of the slot 211, the first elastic member 300 may eject the image capturing device 200 out of the mounting groove 130, such that the user may take the image capturing device 200 easily.

As shown in FIGS. 1 to 3, the terminal device 100 may substantially be a rectangular cube. The terminal device 100 may include a rear wall 111 and a side wall connected to an outer periphery of the display screen 120. The rear wall 111 may be disposed on the side of the terminal device 100 opposite to the display region and may be connected to the side wall. The side wall may include a left side wall 112, a right side wall 114 opposite to the left side wall 112, a top side wall 116, and a bottom side wall 118 opposite to the top side wall 116. The left side wall 112 and the right side wall 114 are disposed between the top side wall 116 and the bottom side wall 118. The top side wall 116 and the bottom side wall 118 are disposed between the left side wall 112 and the right side wall 114. The mounting groove 130 may be defined in the rear wall 111 and extend through the rear wall 111 along a thickness direction of the terminal device 100, i.e. the mounting groove 130 may be a through hole defined in the rear wall 111. The mounting groove 130 may be defined between the left side wall 112 and the right side wall 114, and between the top side wall 116 and the bottom side wall 118. Further, the terminal device 100 may include a middle board 140, disposed between the display screen 120 and the rear wall 111. The first elastic member 300 may be connected to the middle board 140. The middle board 140 and the side wall may be formed integrally. Alternatively, the middle board 140 may be detachably connected to the side wall. Structural stability of the first elastic member 300 may be improved by configuring the middle board 140 to support the first elastic member 300.

As shown in FIG. 7 and FIG. 8, a side of the rear wall 111 opposite to the display region may define a groove 150 extending through the rear wall 111 along the thickness direction of the terminal device 100. The lock tongue 400 may include a body portion 410 and a slide block 420 connected to the body portion 410. The slide block 420 may be received in and extend through the groove 150. The body portion 410 may switch between the first position and the second position by slidable engagement between the slide block 420 and the groove 150. Further, the groove 150 may include a slide groove 151 and a reservation groove 153 communicating with the slide groove 151. The slide block 420 may include a limiting portion 421 and a connection portion 423. In some embodiments, the limiting portion 421 and the connection portion 423 may be connected to each other, whereas in some embodiments, the limiting portion 421 and the connection portion 423 may be integrally formed as an overall structure. The connection portion 423 may be received in and extend through the reservation groove 153, and may be connected to the body portion 410. Connection between the connection portion 423 and the body portion 410 may include, but is not limited to, detachable connection and fixed connection. The limiting portion 421 may be slidably received in the slide groove 151 and may be exposed from the side of the rear wall 111 opposite to the display region. The user may slide the limiting portion 421 along the slide groove 151 to allow the body portion 410 to switch between the first position and the second position.

Further, in one implementation, a size of a cross section of the reservation groove 153 may be greater than that of the connection portion 423, and the size of the cross section of the reservation groove 153 may be less than that of the limiting portion 421. For example, in some embodiments, a distance between two opposite walls of the reservation groove 153 along a length direction of the terminal device 100 may be greater than a distance between an upper surface and a lower surface of the connection portion 423 along the length direction of the terminal device 100, but less than a distance between an upper surface and a lower surface of the limiting portion 421 along the length direction of the terminal device 100. In this way, the connection portion 423 and the body portion 410 may be engaged easily, and a position that the limiting portion 421 may slide to reach may be limited by the walls of the reservation groove 153, preventing a tilted limiting portion 421 from being received in the reservation groove 153, such that reliability of movement of the lock tongue 400 may be improved.

As shown in FIG. 8, in one embodiment, the mobile terminal 10 may include a second elastic member 160. One end of the second elastic member 160 may abut against the body portion 410, and the other end of the second elastic member 160 may abut against the terminal device 100. The second elastic member 160 may push the body portion 410 from the second position to the first position, such that the body portion 410 may be received in the mounting groove 130. In one embodiment, the second elastic member 160 may be a spring, and may allow the lock tongue 400 to be reset easily, such that the lock tongue 400 may protrude from the wall of the mounting groove 130 to be at least partially received in the mounting groove, and may securely lock the image capturing device 200 while being in the first position. In other embodiments, the second elastic member 160 may be an elastic post, an elastic sheet, and the like. It should be understood that, the first elastic member 30 may be a spring, an elastic post, an elastic sheet, and the like, which will not be illustrated in more detail herein. It should be understood that, the second elastic member 160 may be omitted. The image capturing device 200 may be securely received in the mounting groove 130 by configuring the lock tongue 400 to slide relative to the rear wall 111 to be received into the slot 211 of the image capturing device 200.

As shown in FIG. 7 and FIG. 8, the terminal device 100 may have a first groove wall 141 and the second groove wall 143 opposite to first groove wall 141. For example, in one embodiment, the first and the second groove walls may be the walls of the mounting groove 130. One end of the first groove wall 141 may be connected to the middle board 140, and another end of the first groove wall 141 may be connected to the rear wall 111. One end of the second groove wall 143 may be connected to the middle board 140, and another end of the second groove wall 143 may be connected to the rear wall 111. The second groove wall 143 may be inclined towards a side at which the bottom side wall 118 is arranged to form a draft angle, i.e. a distance between the another end of the second groove wall 143 and the bottom side wall 118 may be less than a distance between the one end of the second groove wall 143 and the bottom side wall 118. When the lock tongue 400 moves to reach the second position to unlock the image capturing device 200 with the terminal device 100, the draft angle may allow the image capturing device 200 to be ejected from the mounting groove 130 easily, such that the user may take the image capturing device 200 out of the mounting groove 130 easily.

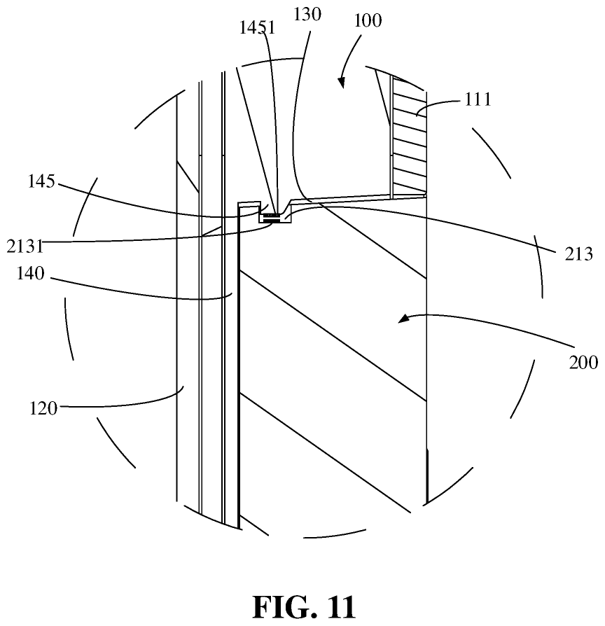

Compared to the second groove wall 143, the first groove wall 141 may be closer to the top side wall 116. In the first position, the body portion 410 may protrude from the second groove wall 143. Further, as shown in FIG. 11, a protrusion 145 may be arranged on the first groove wall 141. The protrusion 145 may protrude from the first groove wall 141, extending towards the mounting groove 130. The cover 210 may define a positioning recess 213 corresponding to the protrusion 145. After the image capturing device 200 received in the mounting groove 130, the protrusion 145 may be received in the positioning recess 213 and fastened with a wall of the positioning recess 213. Fastening the protrusion 145 with the wall of the positioning recess 213 may allow the image capturing device 200 to be positioned inside the mounting groove 130 easily, and allow the user to mount the image capturing device 200 into the mounting groove 130 securely, preventing the image capturing device 200 from being detached from the mounting groove 130 easily.

Further, as shown in FIG. 5 and FIG. 6, the image capturing device 200 may substantially be a rectangular cube. The cover 210 may include a front end face 215, a rear end face 217 opposite to the front end face 215, and a side end face connected to the front end face 215 and the rear end face 217. The side end face may include a left end face 212, a right end face 214 opposite to the left end face 212, a top end face 216, and a bottom end face 218 opposite to the top end face 216. The left end face 212 and the right end face 214 may be disposed between the top end face 216 and the bottom end face 218. The top end face 216 and the bottom end face 218 may be disposed between the left end face 212 and the right end face 214. The light incidence face 221 may be exposed from the front end face 215. The slot 211 may be defined in a side at which the bottom end face 218 is disposed. In the embodiment where the image capturing device 200 defines the positioning recess 213, the positioning recess 213 may be defined in the side at which the top end face 216 is disposed. When the image capturing device 200 is received in the mounting groove 130, the front end face 215 may flush with an outer surface of the rear wall 111. After the image capturing device 200 having the above-mentioned structure is received in the mounting groove 130, an appearance of the mobile terminal 10 may be highly maintained as an integral. In one embodiment, the light incidence face 221 may protrude form the front end face 215. In this way, a position of the image capturing device 200 at which the light incidence face 221 is disposed may be relatively thick, and other positions of the image capturing device 200 may be relatively thin. In this way, the image capturing device 200 may be light and thin, and the mobile terminal 10 may be light and thin.

In one embodiment, the image capturing device 200 may include a module contact 2131, and the terminal device 100 may include a device contact 1451. When the image capturing device is received in the mounting groove 130, the module contact 2131 may be in contact with and connected to the device contact 1451, such that the terminal device 100 may charge the image capturing device 200. In this way, the terminal device 100 may easily charge the image capturing device 200, and the image capturing device 200 may remain sufficient power to be used by the user easily. It should be understood that each of the module contact 2131 or the device contact 1451 may be a metal contact, and may have various structural forms. For example, the image capturing device 200 may define a hole, and the metal contact may be received in the hole, serving as the module contact 2131. The terminal device 100 may be arranged with a protruded metal contact, serving as the device contact 1451. The terminal device 100 charging the image capturing device 200 may be achieved by engaging the module contact 2131 with the device contact 1451. Further, in one implementation, the protrusion 145 may have the metal contact structure, serving as the device contact 1451, and the metal contact may be received in the positioning recess 213 to serve as the module contact 2131.

As shown in FIG. 5 and FIG. 6, the image capturing device 200 may include a module main board 240 in the cover 210. The second power module 230 may be stacked on the module main board 240 and supply power for the module main board 240. The module main board 240 may be communicatively connected to the camera module 220 and the second wireless communication module 250. The module main board 240 may include a circuit board and a plurality of electronic elements connected to the circuit board. The module main board 240 may process image information collected by the camera module 220, and send the image information to the terminal device 100 via the second wireless communication module 250. The module main board 240 may define a first through hole 241 to allow the module main board 240 to be substantially ring-shaped. The camera module 220 may include a lens tube 223, the light incidence face 221 may be exposed at an end of the lens tube 223, and the lens tube 223 may be received in and extend through the first through hole 241. In this way, the lens tube 223 may not stack above the module main board 240, and therefore, internal elements of the image capturing device 200 may be arranged compactly, and an overall thickness of the image capturing device 200 may be reduced.

Further, the second power module 230 may define a second through hole 231 to allow the second power module 230 to be substantially ring-shaped. The second through hole 231 may communicate with the first through hole 241. The lens tube 223 may extend through the first through hole 241 and the second through hole 231. In this way, the lens tube 223 may not stack above the second power module 230. Therefore, the internal elements of the image capturing device 200 may be arranged compactly, and the overall thickness of the image capturing device 200 may be reduced. It should be understood that each of the first power module 170 and the second power module 230 may include a battery able to repeatedly charge and discharge, such as a lithium battery. In other embodiments, each of the first power module 170 and the second power module 230 may be a fuel battery or other types of batteries. The second power module 230 may be connected to the module main board 240 through a power flexible printed circuit board (FPC), such that the second power module 230 may supply power for the module main board 240, which will not be described in detail herein.

Various technical features of the above-mentioned embodiments may be combined arbitrarily. In order to provide a concise description, all possible combinations of the various technical features in the above-mentioned embodiments are not described. However, as long as there is no contradiction in the combination of these technical features, all the combinations should be included in the scope of the present disclosure.

The above-mentioned embodiments only show several implementations of the present disclosure, and the several implementations are described in specific details, but it should not be understood as a limitation of the scope of the present disclosure. It should be noted that for those ordinary skilled in the art, without departing from the concept of the present disclosure, various modifications and improvements may be made and should fall within the scope of the present disclosure. Therefore, the scope of the present disclosure shall be subject to the appended claims.

What is claimed is:

1. A mobile terminal, comprising:
a terminal device, comprising a display screen, a first power module, and a first wireless communication module, wherein the first power module is configured to supply power for the display screen and the first wireless communication module, a side of the terminal device opposite to a display region of the display screen defines a mounting groove;
an image capturing device, comprising a cover, a camera module, a second power module, and a second wireless communication module, wherein the second power module is configured to supply power for the camera module and the second wireless communication module, the camera module and the second power module are disposed inside the cover, the camera module has a light incidence face exposed from the cover, the image capturing device is capable of being received in the mounting groove to allow the light incidence face to be exposed from the side of the terminal device opposite to the display region, the cover defines a slot;
a first elastic member, connected to the terminal device and protruding from a wall of the mounting groove and extending towards the mounting groove; and
a lock tongue, slidably connected to the terminal device and capable of sliding to reach a first position and a second position, wherein after the image capturing device is received in the mounting groove, wherein
the lock tongue is at least partially received in the slot and fastened with a wall of the slot, the image capturing device is locked in the mounting groove, and the first elastic member abuts against the image capturing device, when the lock tongue is at the first position; and
the lock tongue is released from the slot, and the first elastic member is configured to eject the image capturing device out of the mounting groove to allow the image capturing device to be detached from the mounting groove, when the lock tongue is at the second position.

2. The mobile terminal as claimed in claim 1, wherein the terminal device comprises a rear wall and a side wall connected to an outer periphery of the display screen;
the rear wall is disposed on the side of the terminal device opposite to the display region and is connected to the side wall;
the side wall comprises a left side wall, a right side wall opposite to the left side wall, a top side wall, and a bottom side wall opposite to the top side wall;
the left side wall and the right side wall are disposed between the top side wall and the bottom side wall;
the top side wall and the bottom side wall are disposed between the left side wall and the right side wall;
the mounting groove extends through the rear wall; and
the mounting groove is defined between the left side wall and the right side wall, and is defined between the top side wall and the bottom side wall.

3. The mobile terminal as claimed in claim 2, wherein a side of the rear wall opposite to the display region defines a groove extending through a thickness of the rear wall;
the lock tongue comprises a body portion and a slide block connected to the body portion;
the slide block extends through the groove; and
the body portion is switched between the first position and the second position by sliding engagement between the slide block and the groove.

4. The mobile terminal as claimed in claim 3, wherein the groove comprises a slide groove and a reservation groove communicating with the slide groove;
the slide block comprises a limiting portion and a connection portion, the limiting portion and the connection portion are connected with each other to be an integral structure;
the connection portion is received in and extends through the reservation groove and is detachably connected to the body portion; and
the limiting portion is slidably received in the slide groove and is exposed from the side of the rear wall opposite to the display region.

5. The mobile terminal as claimed in claim 4, wherein a size of a cross section of the reservation groove is greater than that of the connection portion, and the size of the cross section of the reservation groove is less than that of the limiting portion.

6. The mobile terminal as claimed in claim 4, further comprising a second elastic member, wherein one end of the second elastic member abuts against the body portion, the other end of the second elastic member abuts against the terminal device; and
the second elastic member is configured to push the body portion from the second position to the first position to allow the body portion to be at least partially received in the mounting groove.

7. The mobile terminal as claimed in claim 3, wherein the terminal device has a first groove wall and a second groove wall opposite to the first groove wall;
compared to the second groove wall, the first groove wall is closer to the top side wall;
the body portion protrudes from the second groove wall when the lock tongue is at the first position;
the first groove wall is arranged with a protrusion, the protrusion protrudes from the first groove wall and extends towards the mounting groove;
the cover defines a positioning recess; and
after the image capturing device is received in the mounting groove, the protrusion is received in the positioning recess and fastened with a wall of the positioning recess.

8. The mobile terminal as claimed in claim 7, wherein the second groove wall is inclined towards a side at which the bottom side wall is disposed to serve as a draft angle.

9. The mobile terminal as claimed in claim 1, wherein the image capturing device comprises a module contact, the terminal device comprises a device contact; and
when the image capturing device is received in the mounting groove, the module contact is in contact with and connected to the device contact to allow the terminal device to charge the image capturing device.

10. The mobile terminal as claimed in claim 1, wherein the image capturing device comprises a module main board disposed inside the cover;
the second power module is stacked on the module main board and is configured to supply power for the module main board;
the module main board is communicatively connected to the camera module and the second wireless communication module; and
the module main board defines a first through hole, the camera module comprises a lens tube, the light incidence face is exposed at an end of the lens tube, and the lens tube extends through the first through hole.

11. The mobile terminal as claimed in claim 10, wherein the second power module defines a second through hole, the second through hole communicates with the first through hole, and the lens tube extends through the second through hole.

12. A mobile terminal, comprising:
a terminal device, comprising a display screen and a first wireless communication module, wherein the display screen has a display region, and a side of the terminal device opposite to the display region defines a mounting groove;
an image capturing device, detachably connected to the terminal device and comprising a cover, a camera module, and a second wireless communication module, wherein
the cover defines a slot, the camera module is disposed inside the cover;
the camera module has a light incidence face;
when the image capturing device is received in the mounting groove, the light incidence face is exposed from the side of the terminal device opposite to the display region;
the image capturing device is communicatively connected to the first wireless communication module through the second wireless communication module;
a first elastic member, connected to the terminal device, protruding from a wall the mounting groove, and extending towards the mounting groove; and
a lock tongue, slidably connected to the terminal device, wherein
the lock tongue is capable of sliding to reach a first position and a second position;
when the image capturing device is received in the mounting groove, the lock tongue is slidable to reach the first position, and the lock tongue is fastened with a wall of the slot to maintain the image capturing device to be received in the mounting groove, and the first elastic member abuts against the image capturing device; and
the lock tongue is slidable to reach the second position to be released from the slot, and the first elastic member is configured to eject the image capturing device out of the mounting groove.

13. The mobile terminal as claimed in claim 12, wherein the terminal device comprises a rear wall and a side wall connected to an outer periphery of the display screen;
the rear wall is disposed on the side opposite to the display region and is connected to the side wall; and
the mounting groove is defined to extend through a thickness of the rear wall.

14. The mobile terminal as claimed in claim 13, wherein the cover comprises a front end face, a rear end face opposite to the front end face, and a side end face connected between the front end face and the rear end face;
the side end face comprises a left end face, a right end face opposite to the left end face, a top end face, and a bottom end face opposite to the top end face;
the left end face and the right end face are disposed between the top end face and the bottom end face;
the top end face and the bottom end face are disposed between the left end face and the right end face;
the light incidence face is exposed from the front end face; and
when the image capturing device is received in the mounting groove, the front end face flushes with an outer surface of the rear wall.

15. The mobile terminal as claimed in claim 13, wherein a side of the rear wall opposite to the display region further defines a receiving groove communicating with the mounting groove;
the lock tongue comprises a body portion and a slide block connected to the body portion;
the slide block is received in the receiving groove; and
the slide block is slidable along the receiving groove to drive the body portion to switch between the first position and the second position.

16. The mobile terminal as claimed in claim 15, wherein the groove comprises a slide groove and a reservation groove;
the slide block comprises a limiting portion and a connection portion, the limiting portion and the connection portion are connected with each other;
the connection portion is received in and extends through the reservation groove and is connected to the body portion; and
the limiting portion is slidably received in the slide groove and is exposed from the side of the rear wall opposite to the display region.

17. The mobile terminal as claimed in claim 16, wherein a size of a cross section of the reservation groove is greater than that of the connection portion, and the size of the cross section of the reservation groove is less than that of the limiting portion.

18. A photographing system, capable of switching between a first state and a second state, and comprising:
a first device, comprising a body and a first communication module, wherein
the body comprises a front side, a rear side opposite to the front side;
the first communication module is disposed inside the body; and
the rear side is recessed inwardly to define a first chamber and a second chamber;
a second device, comprising a cover, a camera module, and a second communication module, wherein
the cover defines a slot, the camera module and the second communication module are disposed inside the cover;
the camera module has a light incidence face, and the light incidence face is exposed from the cover of the second device; and
the second communication module is communicatively connected to the first communication module; and
an engaging assembly, comprising a lock tongue and an elastic member, wherein
the lock tongue is at least partially received in the second chamber and is slidable relative to the rear side to be received in the first chamber or to be taken out of the first chamber;
the elastic member is connected to the first device and disposed on a wall of the first chamber;
when the photographing system is in the first state, the second device is received in the first chamber, the lock tongue is at least partially received in the first chamber, further received in the slot, and fastened with a wall of the slot, the elastic member is elastically deformed and abuts against the second device, and the light incidence face is exposed from the rear side of the first device;
when the lock tongue slides to be out of the first chamber, the second device is capable of being taken out of the first chamber, and the photographing system is in the second state; and
when the photographing system is in the second state, the second device is released from the first chamber, the lock tongue is at least partially received in the first chamber, and the elastic member protrudes from the wall of the first chamber and is at least partially received in the first chamber.

19. The photographing system as claimed in claim 18, wherein
the lock tongue comprises a body portion and a slide block connected to the body portion;
the slide block extends through the second chamber;
the body portion is switched between a first position and a second position by sliding the slide block in the second chamber, when the photographing system is in the first state, the body portion is at the first position, and when the photographing system is in the second state, the body portion is at the second position;
the second chamber comprises a slide groove and a reservation groove communicating with the slide groove;
the slide block comprises a limiting portion and a connection portion, the limiting portion and the connection portion are connected with each other to be an integral structure;
the connection portion is received in and extends through the reservation groove and is detachably connected to the body portion; and
the limiting portion is slidably received in the slide groove and is exposed from the side of a rear wall opposite to a display region.

20. The photographing system as claimed in claim 19, further comprising another elastic member, wherein one end of the another elastic member abuts against the body portion, the other end of the another elastic member abuts against the first device; and
the another elastic member is configured to push the body portion from the second position to the first position to allow the body portion to be at least partially received in the first chamber.
